(19) United States
(12) Patent Application Publication
(10) Pub. No.: US 2005/0149496 A1
(43) Pub. Date: Jul. 7, 2005

(54) System and method for dynamic context-sensitive federated search of multiple information repositories

(75) Inventors: Rajat Mukherjee, San Jose, CA (US); Howard David Jaffe, Santa Cruz, CA (US)

Correspondence Address: William L. Botjer, PO Box 478, Center Moriches, NY, 11934, US

(73) Assignee: VERITY, INC., SUNNYVALE, CA (US)

(21) Appl. No.: 10/743,196

(22) Filed: Dec. 22, 2003

(51) Int. Cl. G06F 7/00

(52) U.S. Cl. 707/3

(57) ABSTRACT

A system and method for context-sensitive federated search across multiple heterogeneous data sources in real-time are disclosed. A user interface receives search query context information from a user. A decision engine interprets the search query context through an internal query classification system. Data sources relevant to the search query are identified for searching. The identification of data sources is aided by dynamically updated source statistics where relevance factors of various sources with respect to different input search categories are stored. These data sources are suggested to the user. Based on the user selection, search queries are formulated for each source and search results are retrieved via associated communication protocols. These search results are consolidated and formatted for presenting to the user. Further, the relevance of the sources to the input categories are automatically updated based on the result sets and user selections.

### BACKGROUND

The present invention relates generally to querying of data sources through enterprise applications. More specifically, it relates to a system and method for providing simultaneous real-time access to multiple data repositories through a federated search.

The modern global economy is heavily information and knowledge driven. For an organization to survive, making quick and informed decisions is imperative. In order to make such decisions, an enterprise needs to have comprehensive access not only to information available in-house, but also to information available elsewhere outside the enterprise domain.

A large amount of information lies within an enterprise intranet. Over the years, traditional enterprise boundaries have been extended to incorporate newer and more comprehensive sources of information. The advent of the Internet and World Wide Web has added an entirely new dimension to the information landscape. Volumes of information have been made available through extranets, subscription content etc in addition to the publicly available Internet content.

Technology has made creating and storing unstructured information easier than ever, but organizing and accessing such information optimally remains difficult. The simplest approach for accessing information is to manually access a single data source at a time to retrieve pre-processed data. The information derived from a number of such data sources is then put together manually to get an integrated overview. However, this would require submitting multiple queries to multiple systems in order to find information. For instance, an enterprise professional handling a Customer Relationship Management (CRM) application might need to view product information from the databases available over the intranet, past customer contacts from the CRM backend system, partner products from extranet sources and general information available over the internet. Another example would be that of a user who is working within a word processor application. Such a user might need to reference or research data stored locally on his computer as well as located elsewhere like the enterprise intranet as well as over the Internet. The above-mentioned approach is quite inadequate with respect to such organizational needs.

Clearly, the problem is not availability of information, but its optimal accessibility. This gives rise to the need for simultaneous access to multiple data repositories through a common interface. Data warehouses that store large amounts of information at a centralized location solve the problem to some extent. However, setup and maintenance of a data warehouse is extremely expensive. Data needs to be carefully indexed and pre-processed for future access. Besides, this approach often provides out-of-date and redundant information. Further, this approach traditionally applies only to highly structured content.

Digest servers that can send digests of periodically updated information to client machines provide an expensive alternative. The digests need to be exhaustive in order to be useful, which also requires significant network and storage resources to keep them up to date. Besides, individual users would use only a small portion of the digest, making most of the information more or less redundant. In addition, the users don't have dynamic control over the list of data sources from which they need information and they are unable to configure sources of their personal preference.

The current state of the art offers a “Federated Search” as a more effective approach to the accessing of information. A federated search system provides a single-point access to multiple content sources. In a federated search system, a query for search is analyzed and modified into the appropriate syntax for each data source to be searched, since different content sources may have varied access interfaces. These sources are then queried in parallel. Some of the queried data sources may have proprietary relevance ranking schemes for the search results. Thereafter, search results from the different sources are merged and collated using a uniform ranking scheme to produce a consolidated search result.

U.S. patent application No. US 2001/0037332A1 titled “Method And System For Retrieving Search Results From Multiple Disparate Databases” discloses one such system. This system concurrently accesses multiple disparate data sources, whether such databases are available through the Web, or other proprietary internal networks. A user specifies a search query and selects the data sources to be queried from within a multiplicity of sources configured into the system. The system has configured data translators that are specific to each of the queried databases. These translators modify the query into an appropriate syntax for each of the different data sources. Consolidated search results are provided dynamically from the different data sources to the user via a single interface.

Such systems, though they provides single point access to multiple information repositories in real-time, are not seamless. A user may be required to manually perform querying and source selection. The search would be restricted to the keywords entered for a search query without reference to their overall context. The search results would only be as good as the keywords that the user frames for conducting the search.

U.S. patent application No. US 2002/0052880A1 titled “Method And Apparatus For Searching And Presenting Electronic Information From One Or More Information Sources” discloses another similar system for searching a plurality of data sources. It uses context representations (comprising various aspects of a collection of information sources) to describe relations between any particular object and other objects. Information search can be enhanced using these context representations, which can also be dynamically updated. Such systems primarily operate at the application level and represent recommendation systems within a single application.

Moreover, the systems described above do not allow richer context to be developed (that takes into account the application environment the user is working in). Besides, most of such systems lack an effective mechanism for assisting the user in performing a focused search.

Certain products like Query Server™, manufactured by OpenText Corporation, 185 Columbia Street West, Waterloo, Canada, provide similar federated search capabilities. A user's query is broadcast to multiple search-enabled information sources and consolidated results are presented as a single ranked list on an HTML page. Customized relevance ranking algorithms can be applied to the results to conceptually cluster the results as directed by an administrator.

In addition to the requirement of manual query entries and source selection, such systems are typically implemented on enterprise wide servers, and provide search capability to multiple users. However, such systems may not adequately serve individual users who may have varied needs (in accordance with the application they are working with and the nature of information they need access to).

Another product that provides extensive federated search capabilities is Enterprise Search Server (ESS), manufactured by Intelliseek, Inc., 1128 Main Street, 4^{th} Floor Cincinnati, USA. In addition to a single point-search interface for multiple repositories, it provides the ability for adaptive learning, whereby the system tracks the previous search and result patterns for a user. Learning from the previous searches and usage of searched results, it rates the appropriateness of various sources with respect to the user's query. Search queries are routed to different internal as well as external data sources using this information and integrated results are provided accordingly.

In such systems, however, the onus of specifying the exact context of a search query lies on the user. The efficacy of such systems, thus, depends largely upon the way the user frames his queries. Besides, there is no mechanism for assisting the user to perform a more relevant search. Users need to explicitly identify the context of search queries to make a focused search. Also, such systems are directed towards enterprise wide deployment rather than customized installation in accordance with each user's requirements and do not target data that is local on the user's machine (personal data).

In light of the foregoing discussion, there is a need for a personalized federated search system and method that can enable a user to perform a focused search across multiple data repositories in real-time, based not only on his previous search behavior but also on the current query context. The system needs to be suited to the search requirements of a particular user. The requirement of manual search query entry needs to be eliminated. Besides, there is need for a system with the capability of implicitly identifying context rather than the user explicitly specifying it. There is also a need for a system that achieves these objectives without the user having to switch out from his current application.

### SUMMARY

The disclosed invention is directed to a system and method for facilitating dynamic, context-sensitive federated search across multiple heterogeneous data sources. Some of these sources may be local, networked (peer sources), intranet applications or repositories, or Internet content sources.

An object of the invention is to provide context-sensitive federated search of multiple data repositories in real-time.

Another object of the invention is to aid a user in performing a focused search by recommending a set of data sources deemed relevant to the search query context.

Another object of the invention is to interpret the context of a search query without the need for the user to explicitly specify the query context.

Yet another object of the invention is to facilitate the user to conduct federated search from within an application without the need for switching out from the application.

Still another object of the invention to provide a focused search based not only the query context, but also the previous user search patterns and result sets.

The invention achieves the above-mentioned objectives through a dynamic internal query context classification mechanism. The system includes a user interface capable of registering the search query information without the need for manual query entry. A decision engine internally interprets the query information and classifies it into a set of pre-defined input search categories. Based on this classification, the system identifies a set of appropriate data sources, from a list of data sources pre-configured into the system. The identification of data sources is aided by dynamically updated source statistics where relevance factors of various sources with respect to different input search categories are stored.

The identified data sources are then optionally recommended to the user. Based on the final user selections, different data sources are searched. This is done via configurable source modules associated with specific data sources. Each source module formulates search queries specific to the associated data source and communicates with the data source via specific communication protocols. Retrieved search results from the different sources are then consolidated and classified to provide a ranked, integrated result set to the user.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 is a schematic representation of the environment in which the federated search system operates;

FIG. 2 is a flowchart that depicts the basic process steps in accordance with the method of the disclosed invention;

FIG. 3 is a flowchart that depicts the detailed process steps involved in search query interpretation and data source identification, in accordance with an embodiment of the disclosed invention;

FIG. 4 is a block diagram that illustrates the architecture of the decision engine, in accordance with an embodiment of the disclosed invention;

FIG. 5 is a block diagram that illustrates a configuration of the source mapping module, in accordance with a preferred embodiment of the disclosed invention; and

FIG. 6 is a logic flow diagram that illustrates the process of dynamic source mapping and source statistics update.

### DESCRIPTION OF PREFERRED EMBODIMENTS

The disclosed invention provides a system and method for dynamic, context-sensitive federated search of multiple data repositories. Enterprise professionals need to access a variety of content sources simultaneously and in a focused manner. The disclosed invention not only provides users with a single point, real-time access interface to multiple data sources, but also aids them in performing a focused search and retrieve data pertinent to their queries and current activity.

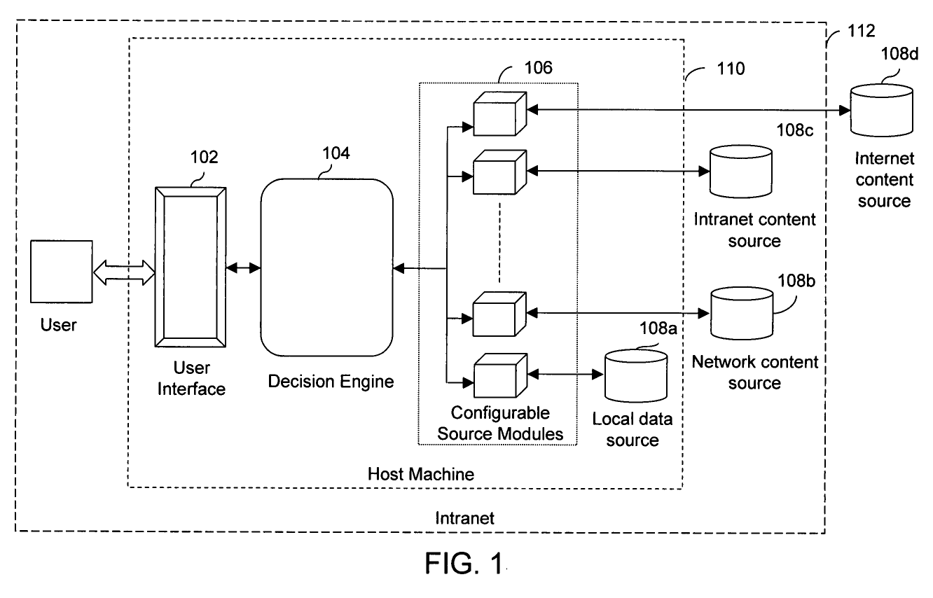

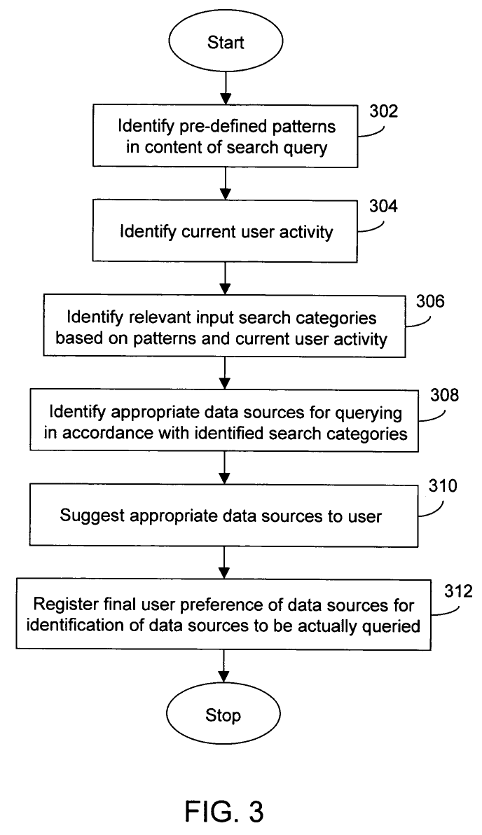

FIG. 1 is a schematic representation of the environment in which the federated search system operates. The system includes a user interface 102, a decision engine 104 and configurable source modules 106, which enable access to multiple heterogeneous data sources 108. User interface 102 is a single-point access interface that allows a user to submit search query information and conduct federated searches across the disparate data sources simultaneously to retrieve data. User interface 102 can optionally be embedded into an application such as a word processor. Decision engine 104 interprets search query contexts and controls the plurality of configurable source modules 106 for querying and retrieving data from data sources 108. The architecture of decision engine 104 will be illustrated in detail in conjunction with FIG. 3.

Data sources 108 may include locally available sources 108a on the host machine 110 (e.g. data stored on secondary storage media like CD, DVD or floppy discs) as well as data sources external to the host machine. External data sources include networked data sources 108b (e.g. data available on peer-to-peer networks), intranet content sources 108c (e.g. a corporate portal or applications like JDBC, Siebel, LDAP or other subscription based content) as well as Internet content sources 108d (e.g. Google, Factiva, Hoovers etc.). The embodiments mentioned here are only exemplary in nature and in no way limit the scope of the invention, which can be implemented for various other internal or external data sources for providing context-sensitive content in real time. In the preferred embodiment of the disclosed invention, different data sources are configured for different users, if the system is deployed on personal workstations.

Each source module 106 is configured for accessing at least one of the plurality of data sources 108. The source modules are configured to store information pertaining to the specific data access interface of data sources associated with them. This includes knowledge of permissible query syntax and other tags. In addition they may also store information relating to the specific communication protocols required for accessing the associated data sources. For instance, internal data sources like network content may require protocols such as telnet. Other locally accessible databases may need the ODBC standard or other database compliant protocols. A peer-to-peer network protocol (e.g., Gnutella) may be used to access peer desktops and workstations on a corporate network. Web resources would require the HTTP protocol for communication to be enabled. It would be evident to a person skilled in the art that the system may be alternatively configured to include other communication protocols for enabling access to specific data sources.

Additionally, for protected sources that need authentication prior to access, the associated source module may store authentication information. Such authentication information may include user-ids and passwords related to the data source. Besides, for subscription content, IP authentication can also be enabled via the source modules. This can be achieved in many ways, e.g., configuration of source-specific authentication parameters in the system, user-provided parameters, cached credentials (e.g., cookies), or internal communications with single-sign-on systems with stored credentials.

User interface 102 may be invoked using any embedded link in an application, like a button or a link. Other similar visual artifacts embedded within the application or elsewhere on the user's machine may also be used. Alternate commands like desktop shortcuts, voice commands or mouse clicks may also be configured for invoking the federated search interface. It would be evident to a person skilled in the art that such embedded links or alternate commands may be configured into the system at the time of installation of the system.

The system of the disclosed invention resides locally on the user's host machine 110. Implementation of the system on the host machine ensures a personalized federated search system that caters to a user's specific needs. In an alternative embodiment, the system may be implemented over a shared enterprise-wide server lying within an enterprise intranet 112. Such a server would cater to multiple users simultaneously, using session management techniques known in the art. For example, a client-side cookie can be established, and passed with the requests to identify a specific user/client. This cookie may then be used by source module control engine 406 for mapping within a predefined set of sources. However, it will be evident to one skilled in the art that the system may not be implemented entirely on a single host machine or a server and may be distributed across an enterprise. Optionally, parts of the disclosed system may be maintained outside the enterprise premises if required. For instance, the system may be provided as a publicly available web site or hosted service, accessible via the Internet.

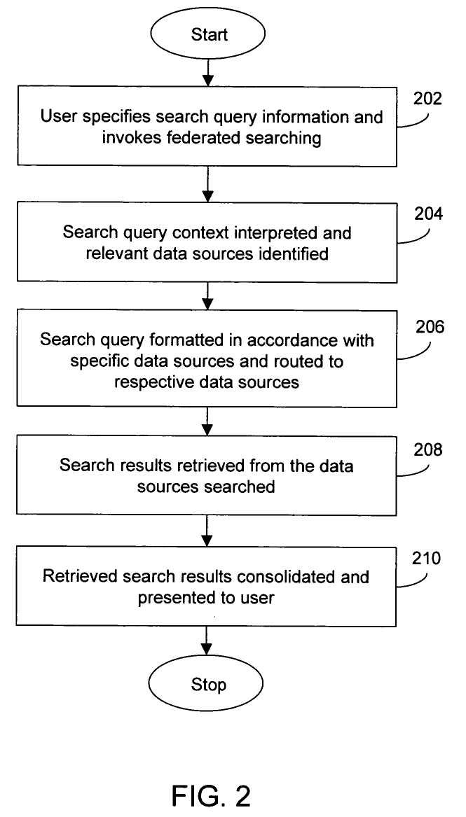

FIG. 2 is a flowchart that describes the basic process steps in accordance with the method of the disclosed invention. At step 202, the user specifies search query context information and invokes federated searching of disparate sources to retrieve data in response to the query. The user may be working within an application and invoke the search from within the application. Some example applications from which the search can be invoked include word processors, web authoring tools, spreadsheets, document publishing systems, ERP or CRM applications or audio editing software.

For specifying the search query context information, the user explicitly selects or highlights a particular section of text in his current application, for which a federated search is to be done. Alternately, the current page, paragraph, or currently selected object (e.g., image/audio file) in the application may be construed to constitute the query context. This may be done, for instance, using optical character recognition (OCR) or voice recognition technologies. Following this, the user invokes the federated search either using an embedded link or an alternative command, as explained earlier.

A Win32 system-wide hook can be used to detect the text and automatically populate this information as the search query information. Hooking is a way to tap into and modify the behavior of existing applications without changing their code. Here, hooking is used for extraction of data rather than any modification in the application. For invoking system hooking, the user provides input to the operating system in the form of an event. Event, for example, can be a keystroke on the keyboard, or clicking with a mouse, which may relocate the cursor. The position of the cursor can be located and the context of the surrounding text can then be used to develop the basis of the context. Multiple events can also be combined for invoking system-wide hooking. This is the case when text is highlighted. For instance when the system detects a MouseDown, followed by a MouseMove and a MouseUp event, it understands that text has been highlighted. When this event sequence is detected, the text within the highlighted area is extracted through additional use of the Win32 API and hooking.

Alternatively, if no selection is made prior to invocation of federated search, the user may manually enter search query information into the user interface. In such a case, user interface 102 appears in the form of a pop-up window with typing area provided for manually submitting search requests.

At step 204, the context of the search query is interpreted and appropriate data sources are identified in accordance with the context of the search query. The context of the search query may be defined in terms of the specific content of the query. In addition the context may be further defined by the application that the user is currently working in, as well as the current activity being performed by the user from within the application. For example, if the user is editing a conference Audio file, it is possible to perform voice recognition, using off-the-shelf software, to construct the context of the search. For video with closed-captioning, this information can be directly extracted. For schematics with text metadata, the metadata can be used. For other images, OCR techniques can yield the context. Based on the identified context, a plurality of data sources relevant for subsequent federated search are determined. Step 204 will be elaborated upon in conjunction with FIG. 3.

Different data sources may have different access interfaces for submitting queries. Hence multiple search queries are formulated at step 206 in accordance with the specific query syntax requirements for different data sources being searched. These queries are then routed to the respective data sources using communication protocols specific to the data sources. These communication protocols are handled by the configured source modules, as explained earlier. At step 208, search results corresponding to the submitted queries in each data source are retrieved. These retrieved search results are then consolidated in accordance with step 210 and presented to the user.

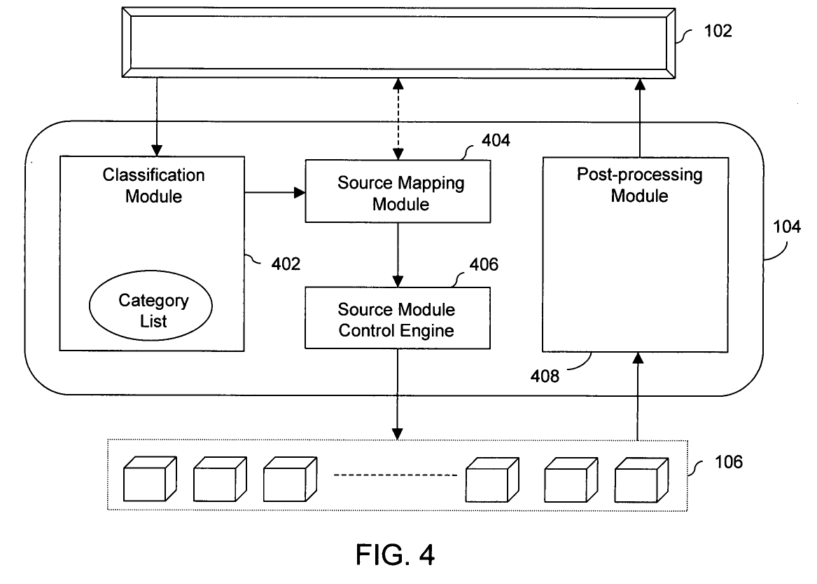

FIG. 3 is a flowchart that describes the detailed process steps involved in search query interpretation and data source identification, in accordance with an embodiment of the disclosed invention. Interpretation of a search query requires identifying its context. For this, at step 302, the search query is analyzed for known patterns or specific keywords or a combination of both. This step will be further explained in conjunction with FIG. 4. At step 304, the current user activity, e.g., editing a text document or analyzing a voice recording of a speech, is identified along with the active application from which federated search was invoked. These may help in further defining context of the search query. Using information gathered at step 302 and step 304, relevant input search categories are identified at step 306. The methodology for identification of relevant input search categories will be further explained in conjunction with FIG. 4. These categories can be pre-defined and provide a standardized representation of the search query in a given application domain.

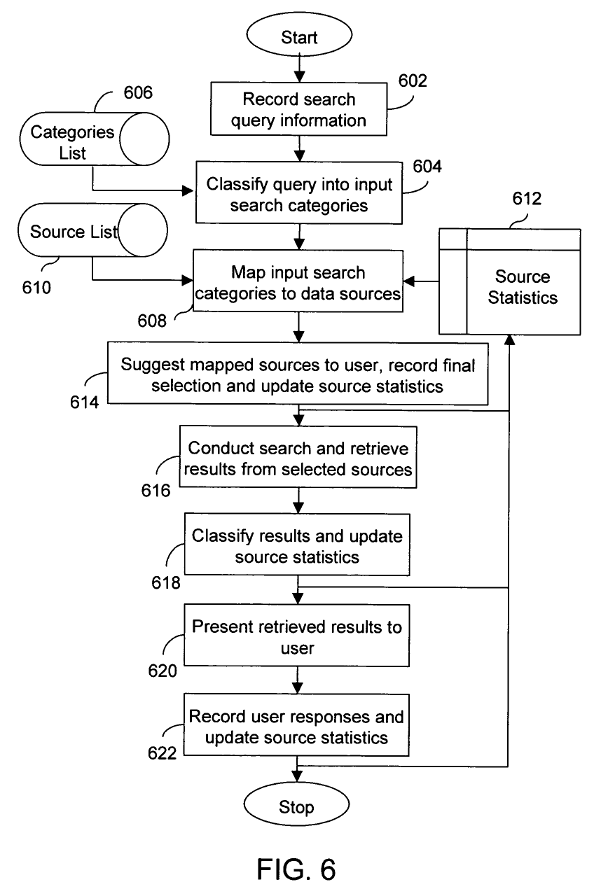

Based on the identified search categories, appropriate data sources for querying are determined at step 308. The step of determining appropriate data sources will be explained in detail in conjunction with FIG. 6. At step 310, the appropriate data sources are suggested to the user, in order to aid the user in subsequently making a focused search. At step 312, the final user preferences are registered with respect to the data sources that need to be searched. These data sources are queried subsequently.

In an alternative embodiment, the steps of suggesting appropriate data sources to the user and registering user response may be bypassed. In other words, the data sources identified as appropriate with respect to the search query context are accessed directly, and the relevant search results are returned to the user.

Alternatively, the user may specify his preferences regarding data sources to be searched at the beginning, while specifying search query information. In this case, the user specified data sources would directly be considered as the sources relevant for searching, and used for subsequent searches that match the same/similar context.

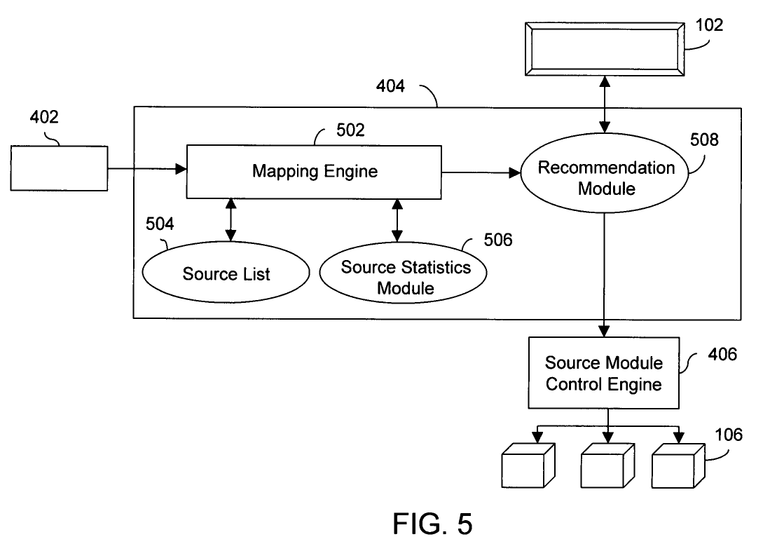

FIG. 4 is a block diagram that illustrates the architecture of decision engine 104, in accordance with an embodiment of the disclosed invention. A classification module 402 receives search query information registered at user interface 102. Classification module 402 further includes a pre-configured list of input search categories, which are subsequently used for determining data sources. Classification module 402 identifies a plurality of search categories corresponding to the search query information. This is done by identifying the context of the search query information and mapping the context on the pre-configured list of search categories. The input search categories identified at classification module 402 are then passed on to source mapping module 404. Source mapping module 404 determines appropriate data sources in accordance with the input search categories. Source mapping module 404 will be further explained in detail in conjunction with FIG. 5.

The list of data sources identified as relevant for querying is passed on to source module control engine 406. Source module control engine 406 activates a plurality of source modules 106, each of the activated source modules being associated with at least one of the data sources identified for querying. The search categories are passed on the activated source modules, which then carry out searches in the respective data sources associated with them. Post-processing module 408 receives the search results returned by each of the active source modules. Post-processing module 408 then merges the search results from multiple data sources and converts them to a presentable form for the user.

In an alternative embodiment, a plurality of post-processing modules may be configured into the system, each post-processing module being associated with one of the source modules. Customized relevance ranking algorithms can be configured into post-processing module for providing ranked search results to the user. Other features such as classifying and clustering of similar results, providing associations among search results etc. can be configured into the system as per a user's requirements. A post-processing module can be used to examine the features or terms of the results in a result set and cluster the results based on correlations among features. Clustering/classification may also be done by matching the result terms to predefined categories. It is also possible for the classification module to retrieve the content of a result prior to access by a user and send it across to an external classification engine for categorization. This methodology may result in higher latency, but has a higher accuracy in terms of clustering similar results.

Classification module 402 interprets the context of the search query for identifying the input search categories corresponding to the search query. This is done using specific rules to map the query content to the set of the pre-configured category list. Various statistical and mathematical models may be used in order to analyze patterns in the search query, and mapping them to certain predefined patterns for various categories. Exemplary models that can be used include support vector machines, Bayesian methods and similar models existing in the art. For instance, a vector space model may be used to define a category as a set of terms, each term having a corresponding weightage indicating its relevance with respect to the category. The input context described by, say, a paragraph of a word processing document can also be defined as a vector in the same space, through a set of relevant feature terms extracted from the paragraph. By evaluating the cosine distance between the context vector and the category vectors, the most relevant category is selected as the matching category, provided it satisfies a certain predefined threshold for the cosine distance. For example, a set of categories may be pre-defined with FELINE as one of the categories. The FELINE category could be represented as follows.

Cat (0.3) Kitten (0.1) Claws (0.1) Tiger (0.1) Leopard (0.1) Cheetah (0.1) Whiskers (0.1) Fur (0.1)

The feature vector of input context can define a paragraph about kittens as follows.

Cat (0.1) Kitten (0.25) Whiskers (0.1) Fur (0.15) Furball (0.3) Siamese (0.1)

The cosine measure for match may be calculated as follows.

0.1×0.3+0.25*0.1+0.1*0.1+0.15*0.1(corresponding to the terms Cat, Kitten, Whiskers and Fur respectively).

Similarly, the cosine measures corresponding to other predefined categories are calculated. The paragraph is matched to the category FELINE if the cosine measure is higher than that for any other pre-defined category.

Another exemplary method may use query terms to match within a document's word index to define categories. Such query engines are well known in the art. Thus a document or paragraph that matched the following query rule with a certain query score threshold, may be considered to be about category FELINES:

“Cat” AND “Whiskers” AND “Claws” AND “Hairball” NOT “Jacksonville” NOT “Car” NOT “Automobile”.

The context may be further specified in terms of the current user activity and the application from within which the federated search is being invoked. For instance, if a user working within an audio editing software invokes the federated search for a specific query related to an audio clip, his query may be preferentially routed to audio sources and related repositories. The context can be an entire paragraph of text, or a full page of text, a passage of text extracted from a voice sample, or an entire document.

FIG. 5 is a block diagram that illustrates a possible configuration of the source-mapping module 404 in accordance with a preferred embodiment of the disclosed invention. Mapping engine 502 interacts with classification module 402 and receives identified input search context categories corresponding to the search query context. Mapping engine 502 further interacts with source list 504 and source statistics module 506 for mapping the input search context categories to the data sources. Source list 504 is a list of data sources configured into the system, maintained with source mapping module 404. Source statistics module 506 stores weighted relevance factors for various configured data sources, with respect to different input search context categories. These relevance factors indicate the appropriateness of content in a data source with respect to a particular search context category. The source statistics information may be static and pre-configured, or may be dynamically updated in accordance with explicit and implicit user feedback. The method of dynamic source mapping and source statistics updating will be explained in detail in conjunction with FIG. 6. Once the mapping engine determines the appropriate data sources, recommendation module 508 presents the configured list of data sources to the user. Additionally, the data sources identified as appropriate are highlighted, so as to aid the user in making a focused search subsequently. The user response, i.e. the selection of data sources made by the user is then registered by recommendation module 508. This information is subsequently passed to source module control engine 406, which in turn activates selected source modules 106 corresponding to the selected data sources, as explained earlier.

In an alternative embodiment, recommendation module 508 may be absent from source-mapping module 404. Mapping engine 502 may determine appropriate data sources with respect to the identified input search categories, and source module control engine may 406 may directly activate relevant source modules. This would obviate the need for the user's intervention in selecting data sources to be searched, while still returning reasonably relevant search results. Alternatively, the user may be made to specify choices of data sources while specifying search query itself. In such a case, the user specified data sources are directly interpreted as the data sources relevant for searching.

FIG. 6 is a logic flow diagram that illustrates the process of dynamic source mapping and source statistics updating as described above in conjunction with FIG. 5. At step 602, search query context information is recorded from the user via user interface 102. At step 604, search query information is analyzed and classified into a plurality of search context categories using input categories list 606. Next, at step 608, the input search context categories are mapped on to appropriate data sources from amongst source list 610, which is a list of all pre-configured data sources. The process of mapping is aided by source statistics 612, which is primarily a compilation of configurable relevance factors of various data sources with respect to different input search context categories, as explained earlier.

Next, at step 614, the sources relevant to the search query context, as mapped at step 608 are presented to the user. Final user selection of data sources is recorded and the source statistics are updated in accordance with the user selection. In other words, the sources that the user finally selects are given a higher weighting with respect to the input categories being searched. Over a period, as the user performs more and more searches, this step ensures higher relevance of the selected sources for a given input context, and personalization of the source statistics in accordance with the user preferences. i.e., the source statistics can also be user-specific.

At step 616, search is conducted in the selected data sources and search results are retrieved, as explained earlier. In an alternative embodiment, step 616 directly follows from step 608 whereby the identified sources are directly searched without the user's intervention.

Next, in accordance with step 618, the results are consolidated and classified in accordance with their relevance. This classification can be done in a manner similar to the classification of search query information, as explained earlier. Alternatively, different classification algorithms may be configured for achieving the objective. For classifying the results, additional result categories (e.g., from a third-party taxonomy) can be used, in addition to those provided in the input categories list. Further, both these lists can be dynamic and change over time. Based on result selection, the relevance factors of the data sources are again updated according to the relevance of results obtained from various sources with respect to the different search categories.

At step 620, the retrieved results are presented to the user. User responses are recorded at step 622 and source statistics is updated accordingly. In other words, if the user views a search result from a particular source, the relevance factor for that source is increased.

In an embodiment of the disclosed invention, source statistics may be configured to store two different lists of relevance factors. One of the lists is updated based on explicit and implicit user feedback and the other is updated in accordance with classification of search results from the different sources.

The process of dynamic source classification and source statistics update results in increased efficiency in the process of federated search. Over a period, as more and more federated searches are performed by a user, the list of sources recommended to the user become more and refined. Besides, being very relevant to the search query, the recommended sources reflect a particular user's preferences as well. Search results are more context-sensitive since the source statistics implicitly assimilates knowledge about a particular context from previous searches.

### Exemplary Embodiment

The operation of the system and method of the disclosed invention can be further explained with the help of an example. Suppose a user is working with a word processor application and is viewing and editing a paper regarding Networking infrastructure. The user highlights a section of the paper that deals with high bandwidth infrastructure. Next, the user clicks on a pre-configured button embedded within the word processor application, to invoke federated search. A Win32 system-wide hook detects the information and automatically populates it as the search query information and communicates it to decision engine 104. Internally, classification engine 402 determines that the input context matches two categories, viz. ‘Networking Infrastructure’ and ‘Fiber Optic Switches’. Thus the user doesn't need to explicitly specify context of the search query, or formulate appropriate search keywords.

A pop-up window displaying the configured data sources appears next, with some data sources already checked. These data sources are identified via dynamic source mapping as already explained in conjunction with FIG. 6. An example set of the checked sources is as follows:

1. Intranet tab
a. Sales database (Has previously yielded results on customer records from Networking Company CISCO)
b. Portal (Intranet has marketing collateral on networking verticals, including information on Nortel and Juniper Networks)

2. Internet tab
a. Factiva (Company information on Networking companies as well as Fiber Optic Switch providers.
b. Moreover (News on networking companies)
c. Hoovers (Financial information on networking companies)

3. References tab
a. Encyclopedia—Networking
b. U.S. Patents—Networking, Fiber Optic
c. European Patents—Mobile Communications
d. Dictionary—Networking
e. C|Net is a general technology source that matched Networking.

4. Network tab
a. John Smith—Colleague who is an expert on Networking since he's indexed a large set of documents on Networking protocols.

Next, the user optionally fine-tunes the auto-selections and initiates the search request. Some of the data sources may be protected and require authentication prior to access. The source modules associated with such sources take care of this. Results from the selected data sources are then returned.

Even before the user selects any results, all results from each source are categorized in accordance with step 618 as already explained. Source statistics 506 are updated based on the relevance of search results from different sources. Thus, if a more relevant result was returned from U.S. Patents, the relevance of this source for the categories “Networking Infrastructure” and “Fiber optic switches” is boosted. This would entail multiplying the pre-configured relevance factor with a specified factor. When the user selects a result from Hoovers, its statistics for the given categories is similarly updated. The source statistics update changes the set of sources recommended for future queries and inputs.

Thus, the disclosed invention enables the user to conduct context-sensitive federated search from within an application. The search can be conducted in real-time with dynamic feedback incorporation in order to make future searches more focused. The invention eliminates the need for explicit context specification from the user. In addition, the user doesn't have to formulate query terms for conducting the search. The system is personalized to keep track of the user's preferences over a period.

The system of the disclosed invention may be deployed as a stand-alone Java application with separate plug-and-play modules and add-ins. Any add-in application program interface (API) that allows inclusion of buttons and triggers on the application's menu may be used for implementing the user interface. Examples of application specific add-ins include the use of COM and ActiveX technologies with Microsoft applications like MSWord, MSOutlook etc. Alternatively, the application may be implemented as a servlet or web application. For instance, the application may be a WAR file or equivalent, implemented on a Java application server, e.g., Apache Tomcat, BEA Weblogic, or IBM Websphere.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

1. A method for context-sensitive querying and retrieval of search results from a plurality of heterogeneous data sources simultaneously, the method comprising the steps of:
a. receiving search query information from a user;
b. interpreting the context of the search query;
c. identifying a plurality of data sources for searching, the data sources being relevant to the identified context of the search query;
d. framing a plurality of search requests pertinent to each of the plurality of data sources identified for searching, each of the search requests being framed in accordance with the search query information in a syntax specific to the data source being searched;
e. executing the plurality of framed search requests via communication protocols specific to each of the data sources being searched, the search requests being executed simultaneously;
f. retrieving search results from the plurality of data sources searched; and
g. consolidating the search results to produce an integrated search result.

2. The method as recited in claim 1 further comprising the step of updating relevance of data sources with respect to the query context, the update being carried out based on the result set and user selection, the updated relevance being used for subsequent searches.

3. The method as recited in claim 1 wherein the step of receiving search query information comprises the step of automated registering of search query information, in response to the user selecting a context within an active application and invoking the search.

4. The method as recited in claim 1 wherein the step of interpreting the context of a search query comprises using statistical or mathematical models for analyzing patterns in the search query for mapping the content of the search query to a set of pre-defined categories in accordance with specific rules.

5. The method as recited in claim 4 wherein the step of interpreting the context of a search query further comprises identifying current activity of the user, and content being processed by the active application the user is currently working in, and the nature of the application.

6. The method as recited in claim 1 wherein the step of identifying a plurality of relevant data sources comprises mapping the identified categories on a set of pre-configured data sources, the mapping being based on relevance factors of data sources with respect to each of the categories, the relevance factors representing appropriateness of content in a data source in relation to the search category.

7. The method as recited in claim 6 wherein the step of identifying the plurality of data sources for searching further comprises the steps of:
a. recommending the data sources identified as relevant to the context of the search query to the user; and
b. registering user specified choices for determining the data sources to be actually searched.

8. The method as recited in claim 1 wherein the step of consolidating the search results comprises classifying search results using classification algorithms and providing relevance ranking to the search results.

9. A method for dynamically determining and suggesting appropriate data sources to a user from amongst a plurality of heterogeneous data sources for searching context-sensitive information in response to a search query by the user, the method comprising the steps of:
a. interpreting the context of the search query, the context being dependent on the current user activity and the specific content of the search query, the step of interpreting the context comprising the steps of:
i. using statistical or mathematical models for analyzing patterns in the search query; and
ii. identifying the current activity of the user, and the application within which the user is working;
b. mapping the context of the search query to a set of search categories;
c. identifying a plurality of data sources relevant to the identified set of search categories using source statistics information, the source statistics information comprising weighted relevance factors of each of the configured data sources with respect to various search categories;
d. recommending data sources identified as relevant to the context of the search query to the user;
e. registering user specified choices for determining the data sources to be searched subsequently;
f. updating the source statistics information in accordance with user specified choices of data sources with respect to the search query categories;
g. updating the source statistics information in accordance with relevance of search results returned by each of the searched data sources; and
h. updating the source statistics information in accordance with implicit and explicit user feedback.

10. The method as recited in claim 9 wherein the step of updating the source statistics information in accordance with implicit and explicit user feedback comprises the steps of:
a. updating weighted relevance factors for the data sources with respect to specific search categories, depending on the retrieved search results actually accessed by the user; and
b. updating weighted relevance factors for the data sources with respect to specific search categories, based on explicit user ratings given to each of the sources.

11. A system for context-sensitive querying and retrieval of search results from a plurality of heterogeneous data sources simultaneously, the system comprising:
a. a user interface receiving search query information;
b. a plurality of source modules, each source module configured to query and retrieve search results based on the search query information, the search results being retrieved from at least one of the plurality of heterogeneous data sources, the source modules storing specific syntax and communication protocol information regarding the associated data sources; and
c. a decision engine interpreting the search query and conducting federated search across relevant data sources, the decision engine comprising:
i. a classification module interpreting the context of the search query and returned results, the context being defined through the specific content of the search query and optionally the current user activity;
ii. a source mapping module identifying a plurality of data sources relevant for searching in accordance with the context of the search query; and
iii. a source module control engine controlling the plurality of source modules for querying and retrieving data from the plurality of heterogeneous data sources.

12. The system as recited in claim 11 wherein the user interface for receiving search query information is invoked from within an application via at least one of: an embedded link in the application, a short-cut key, and an alternate command, and the interface automatically registers search query information selected in the application.

13. The system as recited in claim 11 wherein the decision engine further comprises a post-processing module merging, consolidating and formatting search results from the plurality of data sources searched via source modules.

14. The system as recited in claim 11 wherein the classification module comprises:
a. a predefined set of search categories; and
b. means for using statistical or mathematical models to analyze patterns in the search query and match them to predefined models, in order to map the query to a plurality of the predefined search categories.

15. The system as recited in claim 14 wherein the classification module further comprises means for identifying the current user activity as defined by the current application that the user is working in, in order to get additional context information.

16. The system as recited in claim 11 wherein the source mapping module comprises:
a. a list of pre-configured data sources;
b. means for mapping a plurality of the pre-configured data sources to the identified search categories with respect to the context of a search query; and
c. a recommendation module suggesting the user data sources relevant to the query and registering the user response for identifying data sources to be actually searched, the relevant data sources being the data sources mapped to the identified search categories.

17. The system as recited in claim 16 wherein the source-mapping module further comprises:
a. a source statistics module storing weighted relevance factors for each of the data sources with respect to the predefined search categories; and
b. means for updating the source statistics module, based on user search patterns as well as explicit and implicit user feedback.

18. The system as recited in claim 11 wherein each source module formulates a query representing the search query information, using specific syntax for the data source associated with the source module.

19. The system as recited in claim 11 wherein each source module communicates with the associated data source using the source-specific communication protocol.

20. The system as recited in claim 19 wherein the source module is configured to perform one or more authorization steps for communicating with the corresponding database, the authorization steps being carried out using specific authorization information required for accessing the data source.

21. The system as recited in claim 11 wherein the system is locally installed on a client machine.

22. The system as recited in claim 11 wherein the system resides on an enterprise server.

23. The system as recited in claim 11 wherein the plurality of heterogeneous data sources comprise:
a. locally accessible data sources;
b. shared data sources available over a network; web accessible data sources;
c. subscription based data sources accessible through an enterprise intranet; and
d. extranet based data sources.

24. A computer program product for providing context-sensitive federated search from a plurality of heterogeneous data sources, the computer program product comprising:
a computer readable medium comprising:
a. program instruction means for receiving search query information from a user;
b. program instruction means for classifying search query information into a set of input search categories;
c. program instruction means for mapping the identified categories to a plurality of data sources relevant for searching in accordance with the context of the search query; and
d. program instruction means for querying and retrieving search results from each of the data sources being searched using source specific syntax and communication protocol information.

25. The computer program product as recited in claim 24 wherein the computer readable medium further comprises program instruction means for consolidating and formatting search results from the different sources being searched and presenting them to the user.
